(19) United States
(12) Patent Application Publication
(10) Pub. No.: US 2025/0300895 A1
(43) Pub. Date: Sep. 25, 2025

(54) ANALYSIS METHOD, ANALYSIS SYSTEM, AND STORAGE MEDIUM

(71) Applicant: NEC Corporation, Tokyo (JP)

(72) Inventor: Jun NISHIOKA, Tokyo (JP)

(73) Assignee: NEC Corporation, Tokyo (JP)

(21) Appl. No.: 18/976,510

(22) Filed: Dec. 11, 2024

(30) Foreign Application Priority Data
Mar. 19, 2024 (JP) 2024-043909

(51) Int. Cl. H04L 41/142; H04L 41/0631; H04L 41/16

(52) U.S. Cl. CPC H04L 41/142; H04L 41/0631; H04L 41/16

(57) ABSTRACT

To achieve an analysis system that enables a suitable abnormality detection by acquiring information required for detecting abnormality in a communication system. An analysis system carries out: a process of acquiring control messages exchanged between a plurality of communication apparatuses included in a communication system; a process of generating metrics data which is statistical information, for each of the types of the control messages, on the basis of the control messages; a process of generating event data which is history data on the control messages on the basis of the control message; and a process of detecting occurrence of abnormality in the communication system on the basis of the metrics data and the event data.

### CROSS REFERENCE TO RELATED APPLICATIONS

This application is based upon and claims the benefit of priority from Japanese Patent Application No. 2024-043909 filed on Mar. 19, 2024, the disclosure of which is incorporated herein in its entirety by reference.

### TECHNICAL FIELD

The present disclosure relates to an analysis method, an analysis system, and a storage medium.

### BACKGROUND ART

Conventionally, there have been technologies related to abnormality detection and causal analysis for communication systems. Examples of technologies related to these include the invention disclosed in Patent Literature 1 below.

Patent Literature 1 below discloses a detection apparatus including: a calculation section for referring to a specific log of specific traffic in which a monitoring target whose communication quality is to be monitored is involved, to calculate a chronological statistical value group related to the communication quality of the monitoring target; and a detection section for detecting degradation in the communication quality of the monitoring target by comparing the chronological statistical value group calculated by the calculation section with a threshold value related to the degradation in the communication quality of the monitoring target.

### CITATION LIST

### Patent Literature

### [Patent Literature 1]

Japanese Patent Application Publication, Tokukai, No. 2015-165636

### SUMMARY OF INVENTION

### Technical Problem

In the communication system, a plurality of communication apparatuses operate in an autonomous distributed manner. Therefore, even a network orchestrator do not grasp information exchanged between a plurality of communication apparatuses operating in an autonomous distributed manner.

Further, the technique described in Patent Literature 1 above detects the degradation in communication quality of the monitoring target by comparing the chronological statistical value group related to the communication quality of the monitoring target with the threshold value. However, in some cases, more detailed information is needed in order to carry out abnormality detection and causal analysis on communication systems.

The present disclosure has been achieved in light of the foregoing issue, and it is one example object thereof to provide a technology that enables a suitable abnormality detection by acquiring information required for detecting abnormality in a communication system.

### Solution to Problem

An analysis method in accordance with one example aspect of the present disclosure includes: acquiring control messages exchanged between a plurality of communication apparatuses included in a communication system; generating, based on the control messages, metrics data which is statistical information, for each of the types of the control messages; generating, based on the control messages, event data which is history information on the control messages; and detecting, based on the metrics data and the event data, occurrence of abnormality in the communication system.

An analysis system in accordance with one example aspect of the present disclosure includes at least one processor, the at least one processor carrying out: a process of acquiring control messages exchanged between a plurality of communication apparatuses included in a communication system; a process of generating, based on the control messages, metrics data which is statistical information, for each of the types of the control messages; a process of generating, based on the control messages, event data which is history information on the control messages; and a process of detecting, based on the metrics data and the event data, occurrence of abnormality in the communication system.

A program stored in a non-transitory storage medium, in accordance with one example aspect of the present disclosure causes a computer to carry out: a process of acquiring control messages exchanged between a plurality of communication apparatuses included in a communication system; a process of generating, based on the control messages, metrics data which is statistical information, for each of the types of the control messages; a process of generating, based on the control messages, event data which is history information on the control messages; and a process of detecting, based on the metrics data and the event data, occurrence of abnormality in the communication system.

### Advantageous Effects of Invention

One example aspect of the present disclosure exerts one example advantage of enabling a suitable abnormality detection by acquiring information required for detecting abnormality in a communication system.

### BRIEF DESCRIPTION OF DRAWINGS

FIG. 1 is a block diagram illustrating a configuration example of an analysis system in accordance with the present disclosure.

FIG. 2 is a flowchart illustrating a flow of a procedure of processes carried out by an analysis system in accordance with the present disclosure.

FIG. 3 is a block diagram illustrating a configuration example of an analysis system in accordance with the present disclosure.

FIG. 4 is a view illustrating example templates of BGP.

FIG. 5 is a view illustrating example templates of OSPF.

FIG. 6 is a view illustrating example control messages of 5G core.

FIG. 7 is a view illustrating example training data.

FIG. 8 is a view schematically illustrating abnormality detection using a learning model.

FIG. 9 is a view illustrating example training data and example inference data.

FIG. 10 is a view schematically illustrating identification of a cause of abnormality in a system.

FIG. 11 is a view illustrating one example of a communication system.

FIG. 12 is a view for explaining identification of a cause of abnormality in a communication system.

FIG. 13 is a block diagram illustrating a configuration of a computer that functions as an analysis system in accordance with the present disclosure.

### EXAMPLE EMBODIMENTS

The following description will discuss example embodiments of the present invention. The present invention is not limited to the example embodiments below, but may be altered in various ways by a skilled person within the scope of the claims. For example, the present invention can also encompass, in its scope, any example embodiment derived by appropriately combining technical means employed in the example embodiments described below. Alternatively, the present invention also encompasses, in its scope, any example embodiment derived by appropriately omitting part of technical means employed in the example embodiments described below. The example advantages described in each of the example embodiments below are example advantages expected in that example embodiment, and do not define an extension of the present invention. That is, the present invention also encompasses, in its scope, any example embodiment that does not bring about the example advantages described in the example embodiments below.

### First Example Embodiment

The following description will discuss a first example embodiment, which is an example of an embodiment of the present invention, in detail, with reference to the drawings. The present example embodiment is a basic form of example embodiments described later. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Analysis System 1)

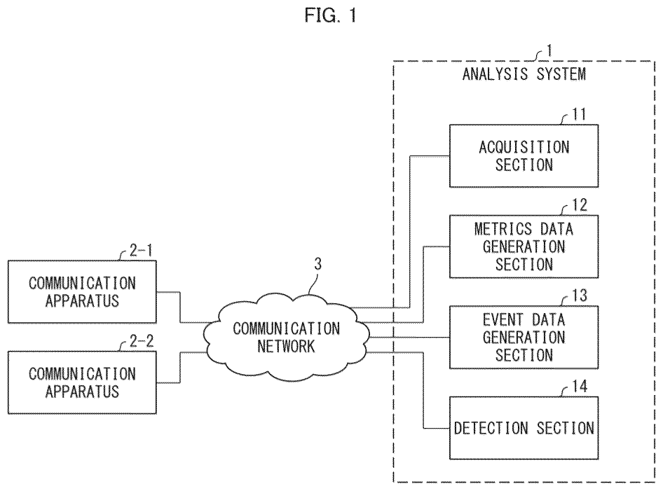

With reference to FIG. 1, the following description will discuss a configuration of an analysis system 1. FIG. 1 is a block diagram illustrating a configuration example of the analysis system 1. The analysis system 1, which is applicable to a system such as the Artificial

Intelligence for IT Operations (AIops), includes an acquisition section 11, a metrics data generation section 12, an event data generation section 13, and a detection section 14, as illustrated in FIG. 1. Note that a system including the analysis system 1, communication apparatuses 2-1 and 2-2, and a communication network 3 is referred to as “communication system”. The communication network 3 is a network used by the analysis system 1 for collecting information from the communication apparatuses 2-1 and 2-2, and another network constituted by the communication apparatuses 2-1 and 2-2 is present.

The acquisition section 11, the metrics data generation section 12, the event data generation section 13, and the detection section 14 are, for example, communicable with each other via the communication network 3. As a specific configuration of the communication network 3, for example, a wireless local area network (LAN), a wired LAN, a wide area network (WAN), a public network, a mobile data communication network, or a combination of these networks can be used, although the present example embodiment is not limited to the specific configurations.

Note that the acquisition section 11, the metrics data generation section 12, the event data generation section 13, and the detection section 14 may be mounted in one apparatus or may be mounted in different apparatuses. Alternatively, the sections may be provided dispersedly in clouds (that is, in the communication network 3). For example, in a case where the sections are mounted in clouds or different apparatuses, information from the sections is transmitted/received via the communication network 3, so that the process proceeds.

The acquisition section 11 acquires control messages exchanged between the plurality of communication apparatuses 2-1 and 2-2 included in the communication system. The communication apparatuses 2-1 and 2-2, which are apparatuses such as switches that can communicate via the communication network 3 or NFs (Network Functions) in, for example, 5G (fifth-generation mobile communication system), operate in an autonomous distributed manner while exchanging control messages with a plurality of apparatuses.

The control messages are messages specified in various control protocols. Examples of the control protocol include the Link Layer Discovery Protocol (LLDP), the Open Shortest Path First (OSPF), the Link Aggregation Control Protocol (LACP), and the Border Gateway Protocol (BGP) that are protocols in which communication is made by switches; the Network Configuration Protocol (Netconf), the Simple Network Management Protocol (SNMP), the OpenFlow, and the External BGP (eBGP) that are control protocols using controllers; the Synchronous Ethernet (SyncEther) (registered trademark) and the Ethernet (registered trademark) Operations, Administration, Maintenance (EtherOAM) that are network-level protocols across a plurality of apparatuses; and communication between NFs in the 5G core.

The acquisition section 11 may, for example, receive a control message from a mirror port set at each of the communication apparatuses 2-1 and 2-2 or from an agent placed in each of the communication apparatuses 2-1 and 2-2. The “agent” refers to a software module that moves in a network, and automatically and efficiently transmits/receives information designated by a user.

In a case where the mirror port is set at each of the communication apparatuses 2-1 and 2-2, the mirror port copies packets flowing in the network, and transmits the copied packets to the acquisition section 11. In a case where an agent is placed in each of the communication apparatuses 2-1 and 2-2, the agent may collect packets flowing in the network to generate metrics data and event data described later.

The metrics data generation section 12 generates metrics data which is statistical information, for each of the types of the control messages on the basis of the control messages. For example, metrics data is statistical information, such as the number of transmission per hour, the number of reception per hour, the average transmitted packet length, the average received packet length, the average interval of transmitted packets, the average interval of received packets, and the number of parameters in the message.

The metrics data may include statistical information, such as a CPU utilization rate, a memory utilization rate, a disk write, a disk read, an amount of network transfer, and an amount of network reception, which are not based on the control message. The metrics data is data used for detecting abnormality in an apparatus, such as a server.

The event data generation section 13 generates event data which is history information on the control message on the basis of the control message. The event data is log data on, for example, parameters included in the control message. As described later, it is possible to generate event data with use of a template prepared for each of the control messages of the control protocol.

The detection section 14 detects occurrence of abnormality in the communication system on the basis of the metrics data and the event data. For example, the detection section 14 detects occurrence of abnormality in the communication system with use of a learning model trained with metrics data and event data that are generated from the control message in a normal state. Examples of the learning model include a learning model trained by unsupervised learning.

For example, the detection section 14 generates, as inference data, metrics data and event data from the control messages collected each 4 hours and sequentially inputs the metrics data and the event data at each time point to the learning model. The occurrence of abnormality in the communication system is detected by detecting data at a time point at which the network state is different from a normal state. For example, a possible configuration is that the detection section 14 inputs the inference data to the learning model that has been trained, and in a case where the inference data has a high correlation with the data in a normal state, the detection section 14 determines that the communication system is in a normal state, whereas in a case where the inference data has a low correlation with the data in a normal state, the detection section 14 determines that the communication system is in an abnormal state.

### (Example Advantages of Analysis System 1)

As described above, in the analysis system 1, the metrics data generation section 12 generates metrics data which is statistical information, for each of the types of the control messages on the basis of the control messages. The event data generation section 13 then generates event data which is history information on the control messages on the basis of the control messages. This enables the detection section 14 to suitably carry out abnormality detection by acquiring the metrics data and the event data required for detecting abnormality in the communication system.

### (Flow of Analysis Method)

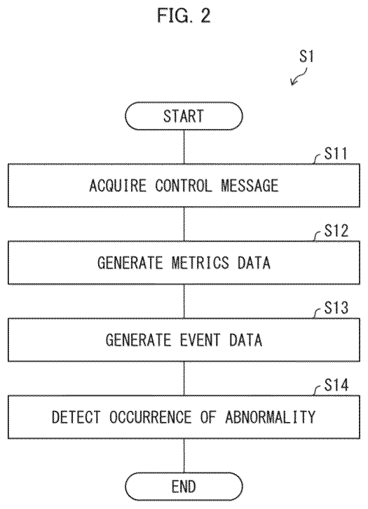

With reference to FIG. 2, the following description will discuss a flow of an analysis method S1. FIG. 2 is a flowchart illustrating the flow of the analysis method S1. As illustrated in FIG. 2, the analysis method S1 includes processes S11 to S14.

First, the acquisition section 11 acquires (S11) control messages exchanged between the plurality of communication apparatuses 2-1 and 2-2 included in the communication system. The communication apparatuses 2-1 and 2-2, which are apparatuses such as switches that can communicate via the communication network 3 or NFs in, for example, 5G, operate in an autonomous distributed manner while exchanging control messages with a plurality of apparatuses. The control messages are messages specified in various control protocols.

The metrics data generation section 12 then generates (S12) metrics data which is statistical information, for each of the types of the control messages on the basis of the control messages. For example, metrics data is statistical information, such as the number of transmission per hour, the number of reception per hour, the average transmitted packet length, the average received packet length, the average interval of transmitted packets, the average interval of received packets, and the number of parameters in the message.

Subsequently, the event data generation section 13 generates (S13) event data which is history information on a control message, on the basis of the control message. The event data is log data on, for example, parameters included in the control message. As described later, it is possible to generate event data with use of a template prepared for each of the control messages of the control protocol.

The detection section 14 detects (S14) occurrence of abnormality in the communication system on the basis of the metrics data and the event data. For example, the detection section 14 detects occurrence of abnormality in the communication system with use of a learning model trained with metrics data and event data that are generated from the control message in a normal state. Examples of the learning model include a learning model trained by unsupervised learning.

### (Example Advantage of Analysis Method)

As described above, in the analysis method S1, the metrics data generation section 12 generates metrics data which is statistical information, for each of the types of the control messages on the basis of the control messages. The event data generation section 13 then generates event data which is history information on the control messages on the basis of the control messages. This enables the detection section 14 to suitably carry out abnormality detection by acquiring the metrics data and the event data required for detecting abnormality in the communication system.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Analysis System 1A)

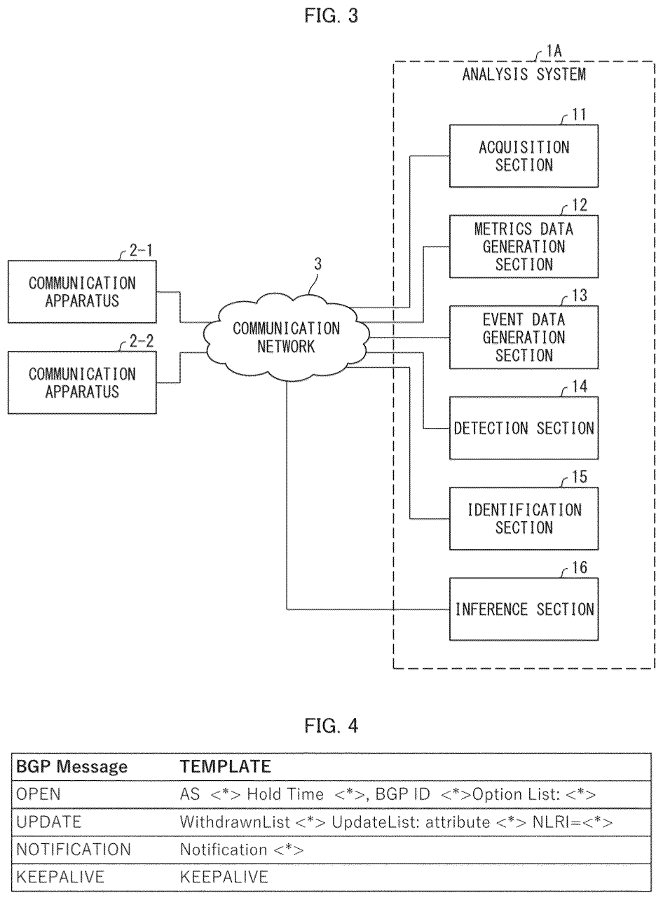

With reference to FIG. 3, the following description will discuss a configuration of an analysis system 1A. FIG. 3 is a block diagram illustrating a configuration of the analysis system 1A. The analysis system 1A includes the acquisition section 11, the metrics data generation section 12, the event data generation section 13, the detection section 14, an identification section 15, and an inference section 16. Note that a system including the analysis system 1A, the communication apparatuses 2-1 and 2-2, and the communication network 3 is referred to as “communication system”.

The acquisition section 11, the metrics data generation section 12, the event data generation section 13, the detection section 14, the identification section 15, and the inference section 16 are, for example, communicable with each other via the communication network 3. As a specific configuration of the communication network 3, for example, a wireless LAN, a wired LAN, a WAN, a public network, a mobile data communication network, or a combination thereof can be used, although the present example embodiment is not limited to the specific configurations.

Note that the acquisition section 11, the metrics data generation section 12, the event data generation section 13, the detection section 14, the identification section 15, and the inference section 16 may be mounted in one apparatus or may be mounted in different apparatuses. Alternatively, the sections may be provided dispersedly in clouds (that is, in the communication network 3). For example, in a case where the sections are mounted in clouds or different apparatuses, information from the sections is transmitted/received via the communication network 3, so that the process proceeds.

The acquisition section 11 acquires control messages exchanged between the plurality of communication apparatuses 2-1 and 2-2 included in the communication system. The communication apparatuses 2-1 and 2-2, which are apparatuses such as switches that can communicate via the communication network 3 or NFs in, for example, 5G, operate in an autonomous distributed manner while exchanging control messages with a plurality of apparatuses.

The metrics data generation section 12 generates metrics data which is statistical information, for each of the types of the control messages on the basis of the control messages. For example, metrics data is statistical information, such as the number of transmission per hour, the number of reception per hour, the average transmitted packet length, the average received packet length, the average interval of transmitted packets, the average interval of received packets, and the number of parameters in the message.

In a case where the control protocol is BGP, the acquisition section 11 collects, for example, statistical information for the last 3 hours at one hour intervals. The metrics data generation section 12 then sets, at one minute intervals, the control messages transmitted and received during the interval, as counting targets. Hereinafter, the control message is also referred to simply as “message”.

For example, as the metrics data, the metrics data generation section 12 generates the number of transmission and the number of reception of the message “OPEN”; the number of transmission, the number of reception, the number of deletion routes, and the number of update routes of the message “UPDATE”; the number of transmission and the number of reception of the message “NOTIFICATION”; and the number of transmission, the number of reception, the transmission interval for each communication target, and the reception interval for each communication target of the message “KEEPALIVE”.

In a case where the control protocol is OSPF, the acquisition section 11 collects, for example, statistical information for the last 3 hours at one hour intervals. The metrics data generation section 12 then sets, at one minute intervals, the control messages transmitted and received during the interval, as counting targets. For example, as metrics data, the metrics data generation section 12 generates the number of transmission, the number of reception, the transmission interval, the reception interval of the message “HELLO”, and the number of neighbors that have exchanged the message “HELLO” per hour; the number of reception of the message “DBD” and the number of LSA headers received in the message “DBD”; the number of transmission of the message “LSR”, the number of reception of the message “LSR”, the number of the pieces of LSA requested in the message “LSR”, and the number of the types of the LSA requested in the message “LSR”; the number of transmission of the message “LSU”, the number of reception of the message “LSU”, the number of the pieces of LSA in the message “LSU”, and the number of the types of the LSA in the message “LSU”; and the number of transmission of the message “LSAck”, the number of reception of the message “LSAck”, and the number of the LSA Headers in the message “LSAck”.

In a case where the control protocol is 5G core, for example, the acquisition section 11 sets, as counting targets, messages regarding Service Operations of the NFs, such as the Access and Mobility Function (AMF) and the Session Management Function (SMF). The metrics data generation section 12 generates, as metrics data, for example, the number of transmitted/received messages for each of the Service Operations per hour.

The event data generation section 13 generates event data which is history information on control messages on the basis of the control messages. The event data is log data on, for example, parameters included in the control message. The event data generation section 13 may generate event data by extracting a parameter with use of a template prepared for each of the control protocols.

FIG. 4 is a view illustrating example templates individually for the types of the BGP messages. The message “OPEN” is a message for starting a BGP session. As illustrated in FIG. 4, for example, an Autonomous System (AS) number is shown in the “*” section, and the event data generation section 13 can acquire the AS number by referring to AS<*>in the message “OPEN”. The event data generation section 13 can similarly acquire other parameters.

The message “UPDATE” is a message used for notifying routing information. The message “NOTIFICATION” is a message for notifying the other side of an error in the protocol. The message “KEEPALIVE” is a message for confirming that the BGP session is in effect. The event data generation section 13 can acquire the parameters of the messages by referring to these templates.

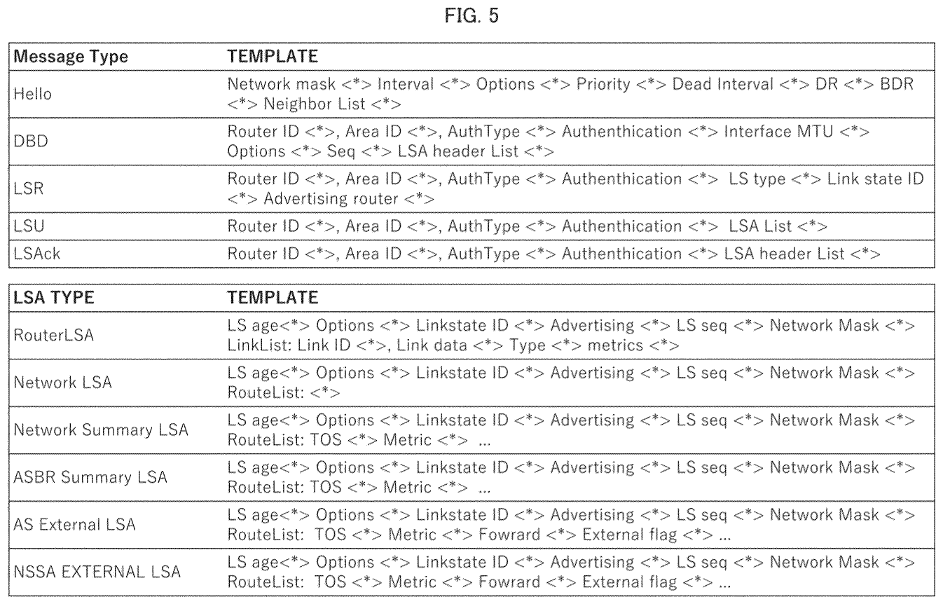

FIG. 5 is a view illustrating example templates of the OSPF. The upper drawing of FIG. 5 is a view illustrating example templates individually for the types of the OSPF messages. The message “Hello” is a message used for, for example, searching for a neighboring router and determining a designated router. The message “DBD”, which is an abbreviation of “Database Description”, is a message for summarizing the contents of the topology database while forming a neighbor relationship, and notifying the summary. The message “LSR”, which is an abbreviation of Link State Request, is a message requesting additional LSA (topology information) in the final stage of the neighbor relationship formation.

The message “LSU”, which is an abbreviation of “Link State Update”, is a message notifying LSA (topology information). The message “LSAck”, which is an abbreviation of “Link State Ack”, is an acknowledgement message in response to the link state update packet.

The event data generation section 13 can acquire the parameters of the messages by referring to these templates.

The lower drawing of FIG. 5 is a view illustrating example templates individually for the types of the LSA information included in the LSU. The “Router LSA” is information on router interfaces in the area. The “Network LSA” is information on a multi-access type network in which a plurality of routers are connected. The “Network Summary LSA” refers to routing information (e.g., next hop, metrics) to an out-of-area (however, intra-AS) network.

The “ASBR Summary LSA” is routing information to an AS border router (ASBR) located out of the area. The “AS External LSA” is routing information to an outside of the AS. The “NSSA External LSA” is routing information to an outside of the AS. The event data generation section 13 can acquire the parameter for each of the types of the LSA information by referring to these templates.

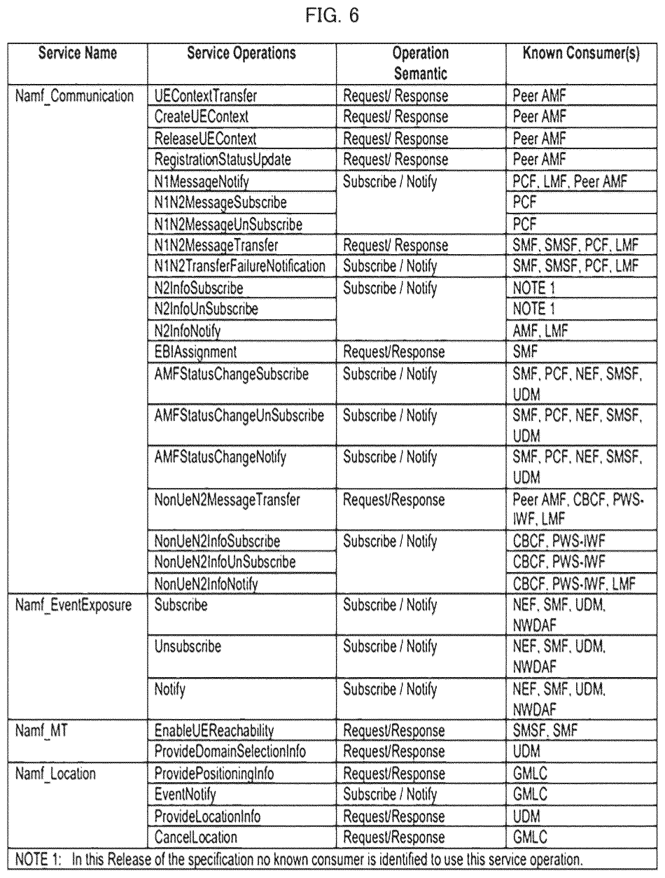

FIG. 6 is a view illustrating Service Operations of the AMF which are examples of the control messages of the 5G core. The event data generation section 13 uses the templates created so as to enable extraction of the parameters of Payloads of the Service Operations messages, to extract parameters included in the messages.

The detection section 14 detects occurrence of abnormality in the communication system on the basis of the metrics data and the event data. For example, the detection section 14 detects occurrence of abnormality in the communication system with use of a learning model trained with metrics data and event data that are generated from the control message in a normal state.

### (Detection of Abnormality in Server)

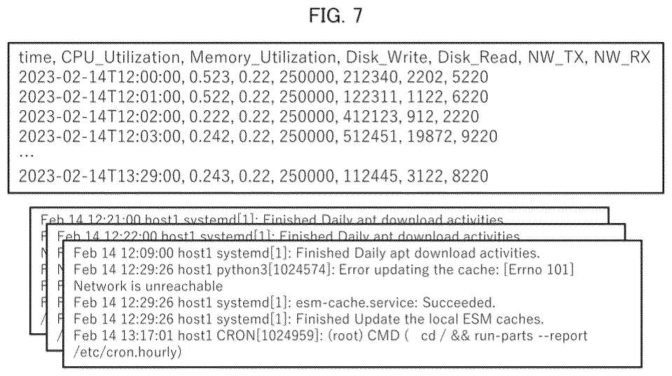

First, the following will briefly describe detection of abnormality in a server. FIG. 7 is a view illustrating example training data for generating a learning model. The upper drawing of FIG. 7 illustrates one example of the metrics data and includes statistical information such as time points, a CPU utilization rate (CPU_Utilization), a memory utilization rate (Memory_Utilization), a disk write (Disk Write), a disk read (Disk Read), an amount of network transfer (Network_TX), and an amount of network reception (Network RX).

The lower drawing of FIG. 7 illustrates one example of event data that monitors whether abnormality is occurring in a server (Host A). This event data includes syslog and Application Log of the server (Host A). In a case where analysis is carried out on a plurality of servers (Host), data is prepared for each of the servers (Host). Note that data in a period during which normal operations are carried out is used as the training data.

The learning model is trained by inputting, into the learning model, metrics data and event data at time points within the same period. In a case where analysis is carried out on a plurality of servers (Host), the learning model is trained to learn data prepared for each of the servers (Host).

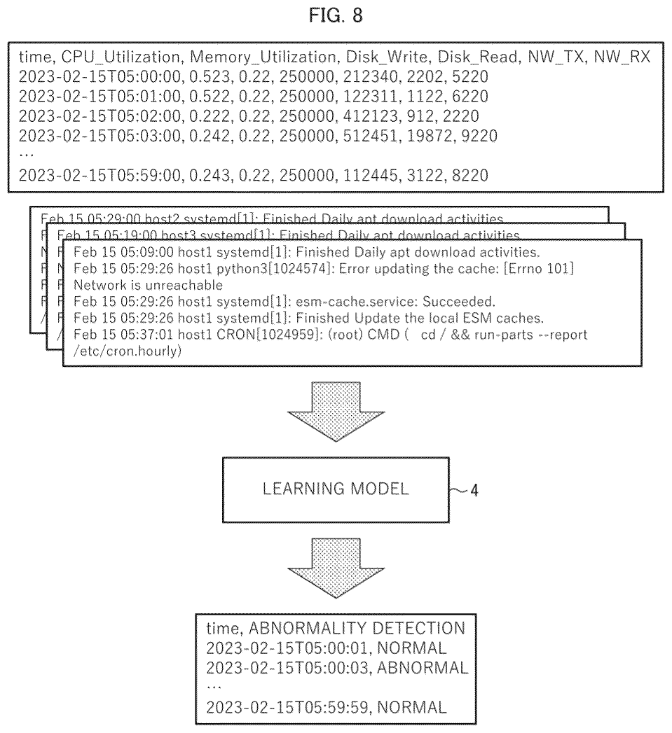

FIG. 8 is a view schematically illustrating abnormality detection using a learning model. The learning model 4 is a learning model that has been trained with the metrics data and the event data in a normal state that are illustrated in FIG. 7. As illustrated in FIG. 8, the detection section 14 inputs, to the learning model 4, the metrics data and the event data at the same time point within a detection target period to determine whether the server is in a normal state or in an abnormal state at that time point.

### (Detecting Abnormality in Communication System)

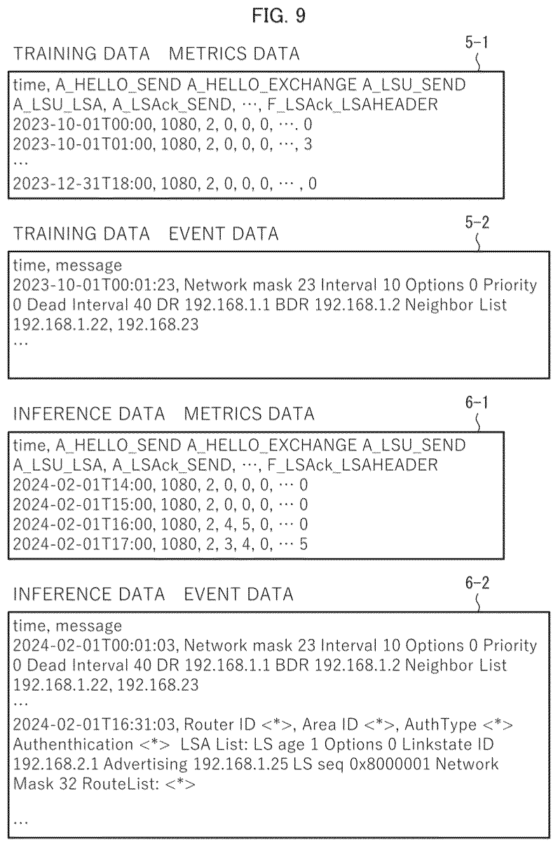

FIG. 9 is a view illustrating another example of training data for generating a learning model. The metrics data 5-1, which is OSPF metrics data as training data, includes statistical information, such as time points, the number of transmission of “HELLO”, the number of neighbors that have exchanged “HELLO”, and the number of the pieces of LSA in “LSU”.

The event data 5-2, which is OSPF event data as training data, includes time points and parameters of messages that have been exchanged. As in the method of training a learning model described with reference to FIG. 7, a learning model that has been trained is generated by training the learning model with the metrics data 5-1 and the event data 5-2.

The metrics data 6-1, which is OSPF metrics data as inference data, includes the same types of data as the metrics data 5-1. The event data 6-2, which is OSPF event data as inference data, includes the same types of data as the event data 5-2. As in the abnormality detection method described with reference to FIG. 8, it is determined, by inputting the metrics data 6-1 and the event data 6-2 to the learning model, whether the communication system is in a normal state or in an abnormal state at that time point.

The identification section 15 identifies a cause of occurrence of abnormality in the communication system on the basis of at least the metrics data and/or the event data.

### (Identification of Cause of Occurrence of Abnormality in Server)

First, the following will briefly describe identification of a case of occurrence of abnormality in a server. For example, in a case where performance indexes of a system application are degraded, the identification section 15 identifies a server that causes the degradation. The identification section 15 uses, as numerical data representing performance indexes of the system application, for example, an average response time to a request to the system and the number of processes per time.

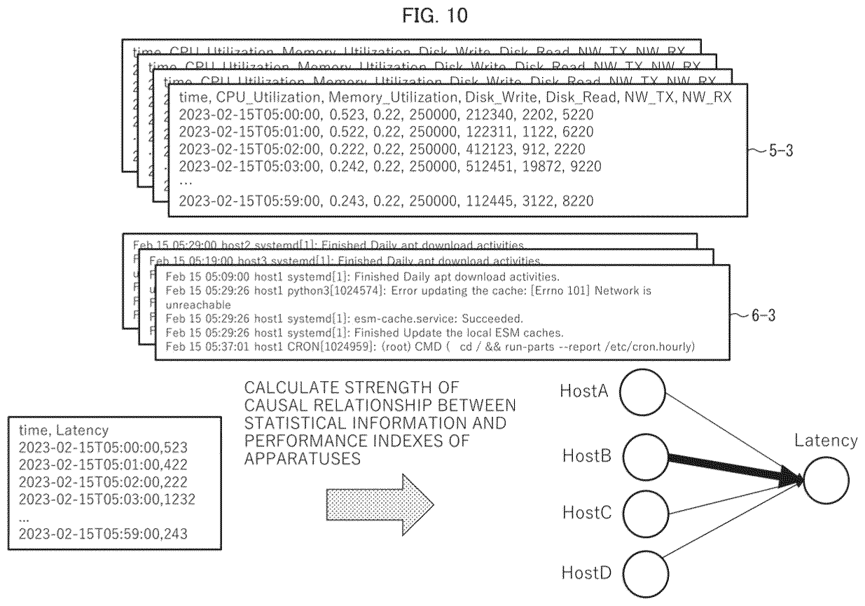

FIG. 10 is a view schematically illustrating identification of a cause of abnormality in a system. The metrics data 5-3 is the same as the metrics data illustrated in the upper drawing of FIG. 8, and data during a period around occurrence of abnormality is used as the metrics data 5-3. The event data 6-3 is the same as the event data illustrated in the lower drawing of FIG. 8, and data during a period around occurrence of abnormality is used as the event data 6-3.

For example, in a case where numerical data representing performance indexes is set as “Latency”, the identification section 15 identifies, as a cause of occurrence of abnormality, an apparatus (HostB) having metrics data exhibiting a behavior having a high causal relationship with a variation in “Latency”. For example, with a weight set for each metrics data in advance, the identification section 15 calculates a score of each of the apparatuses in a period around the occurrence of abnormality, and identifies, as a cause of the occurrence of abnormality, an apparatus having the highest score. For example, as the score, it is possible to use a value obtained by multiplying each metrics data by the weight and then adding up the products.

### (Identification of Cause of Occurrence of Abnormality in Communication Network)

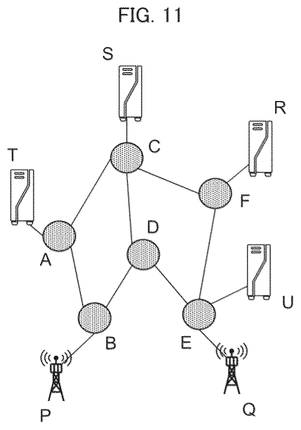

FIG. 11 is a view illustrating one example of the communication system in which apparatuses P to U each communicate with other via communication apparatuses A to F. It is assumed that the communication apparatuses A to F communicate with use of the OSPF.

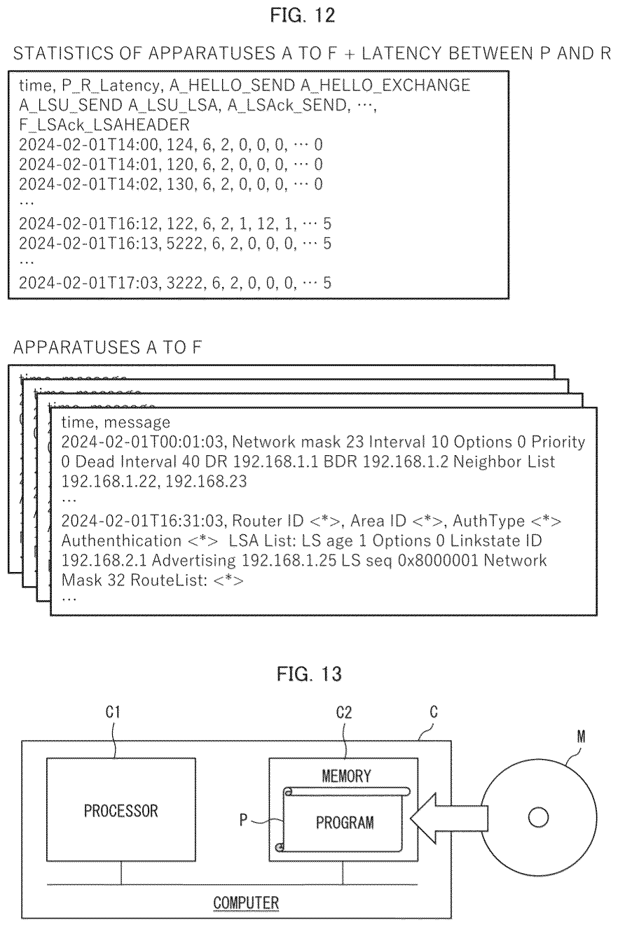

FIG. 12 is a view for explaining identification of a cause of abnormality in the communication system. The following description will discuss a case where another apparatus (not illustrated) monitors the communication system, and increased communication delay between the apparatuses P and R is detected. The metrics data illustrated in the upper drawing of FIG. 12 is metrics data during a period around the communication delay increase, and includes time points, Latency between the P and R, and statistical information on the communication apparatuses A to F.

The event data illustrated in the lower drawing of FIG. 12 is event data during a period around the communication delay increases, and includes time points and log information on the messages of the apparatuses A to F. For example, in a case where numerical data representing performance indexes is set as “Latency”, the identification section 15 identifies, as a cause of occurrence of abnormality, a communication apparatus having statistical information exhibiting a behavior having a high causal relationship with a variation in “Latency”, e.g., the communication apparatus D. For example, with a weight set for each statistical information in advance, the identification section 15 calculates a score of each of the communication apparatuses, and identifies, as a cause of the occurrence of abnormality, the apparatus D having the highest score. The identification section 15 may identify a communication path in which abnormality is occurring, with reference to event data during a period around the communication delay increase.

In a case where the control messages are encrypted, the inference section 16 infers the types of the control messages on the basis of at least packet sizes of the control messages and frequencies of the control messages. Since the header portion is not encrypted even in the control message that has been encrypted, it is possible to determine the type of the control message from, for example, the port number.

For example, the “KEEPALIVE” of BGP consists only of a header, whereas “UPDATE” of BGP includes data on routing information to be updated. The main text of “Route-refresh” has a fixed length, and with “NOTIFICATION”, TCP is closed immediately thereafter. The inference section 16 can determine the type of the control message from these differences.

In a case where the control messages are encrypted, the inference section 16 may infer the types of the control messages encrypted, with use of a learning model trained with, as training data, at least packet sizes of the control messages that are not encrypted, frequencies of the control messages that are not encrypted, and the types of the control messages.

### (Example Advantage of Analysis System 1A)

As described above, in the analysis system 1A, the metrics data generation section 12 generates metrics data which is statistical information, for each of the types of the control messages on the basis of the control messages. This enables the identification section 15 to suitably identify a cause of occurrence of abnormality in the communication system by acquiring metrics data required for identifying the cause of the occurrence of abnormality in the communication system.

Further, in the analysis system 1A, in a case where the control messages are encrypted, the inference section 16 infers the types of the control messages on the basis of at least packet sizes of the control messages and frequencies of the control messages. Therefore, even in a case where the control messages are encrypted, it is possible to suitably infer the types of the control messages.

In the analysis system 1A, in a case where the control messages are encrypted, the inference section 16 infers the types of the control messages encrypted, with use of a learning model trained with, as training data, at least packet sizes of the control messages that are not encrypted, frequencies of the control messages that are not encrypted, and the types of the control messages. Therefore, even in a case where the control message is encrypted, the inference section 16 can suitably infer the type of the control message.

In the analysis system 1A, the event data generation section 13 generates event data by extracting a parameter with use of a template prepared for each of the control protocols. This enables the event data generation section 13 to easily generate event data for each of the control protocols.

### Software Implementation Example

Some or all of the functions of each of the analysis system 1 and 1A may be implemented by hardware such as an integrated circuit (IC chip), or may be implemented by software.

In the latter case, each of the analysis systems 1 and 1A is implemented by, for example, a computer that executes instructions of a program that is software implementing the foregoing functions. FIG. 13 illustrates an example of such a computer (hereinafter, referred to as “computer C”). FIG. 13 is a block diagram illustrating a hardware configuration of the computer C which functions as each of the analysis systems 1 and 1A.

The computer C includes at least one processor C1 and at least one memory C2. The memory C2 stores a program P for causing the computer C to operate as each of the systems above. The processor C1 of the computer C retrieves the program P from the memory C2 and executes the program P, so that the functions of each of the analysis systems 1 and 1A above are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded in a case where the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display, and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present disclosure encompasses techniques described in the supplementary notes below. Note, however, that the present invention is not limited to the techniques described in the supplementary notes below, but may be altered in various ways by a skilled person within the scope of the claims.

(Supplementary note 1)

An analysis method including:
acquiring control messages exchanged between a plurality of communication apparatuses included in a communication system;
generating, based on the control messages, metrics data which is statistical information, for each of the types of the control messages;
generating, based on the control messages, event data which is history information on the control messages; and
detecting, based on the metrics data and the event data, occurrence of abnormality in the communication system.
   (Supplementary note 2)

The analysis method according to supplementary note 1, further including identifying, based on at least one of the metrics data and the event data, a cause of the occurrence of the abnormality in the communication system.

(Supplementary note 3)

The analysis method according to supplementary note 1 or 2, further including inferring, in a case where the control messages are encrypted, the types of the control messages based on at least packet sizes and frequencies of the control messages.

(Supplementary note 4)

The analysis method according to supplementary note 3, wherein in the inferring of the types of the control messages, in a case where the control messages are encrypted, the types of the control messages encrypted are inferred by using a learning model trained with, as training data, at least packet sizes and frequencies of the control messages that are not encrypted and the types of the control messages.

(Supplementary note 5)

The analysis method according to supplementary note 1 or 2, wherein in the generating of the event data, the event data is generated by extracting a parameter with use of a template prepared for each of control protocols.

(Supplementary note 6)

An analysis system including:
acquisition means that acquires control messages exchanged between a plurality of communication apparatuses included in a communication system;
metrics data generation means that generates, based on the control messages, metrics data which is statistical information, for each of the types of the control messages;
event data generation means that generates, based on the control messages, event data which is history information on the control messages; and
detection means that detects, based on the metrics data and the event data, occurrence of abnormality in the communication system.
   (Supplementary note 7)

The analysis system according to supplementary note 6, further including identification means that identifies, based on at least one of the metrics data and the event data, a cause of the occurrence of the abnormality in the communication system.

(Supplementary note 8)

The analysis system according to supplementary note 6 or 7, further including inference means that infers, in a case where the control messages are encrypted, the types of the control messages based on at least packet sizes and frequencies of the control messages.

(Supplementary note 9)

The analysis system according to supplementary note 8, wherein in a case where the control messages are encrypted, the inference means infers the types of the control messages encrypted, by using a learning model trained with, as training data, at least packet sizes and frequencies of the control messages that are not encrypted and the types of the control messages.

(Supplementary note 10)

The analysis system according to supplementary note 6 or 7, wherein the event data generation means generates the event data by extracting a parameter with use of a template prepared for each of control protocols.

(Supplementary note 11)

A control program for causing a computer to operate as the analysis system according to any one of supplementary notes 6 to 10, the program causing the computer to function as each of the means.

### REFERENCE SIGNS LIST

1, 1A Analysis system
2-1, 2-2 Communication apparatus
3 Communication network
4 Learning model
11 Acquisition section
12 Metrics data generation section
13 Event data generation section
14 Detection section
15 Identification section
16 Inference section

1. An analysis method comprising:
acquiring control messages exchanged between a plurality of communication apparatuses included in a communication system;
generating, based on the control messages, metrics data which is statistical information, for each of the types of the control messages;
generating, based on the control messages, event data which is history information on the control messages; and
detecting, based on the metrics data and the event data, occurrence of abnormality in the communication system.

2. The analysis method according to claim 1, further comprising identifying, based on at least one of the metrics data and the event data, a cause of the occurrence of the abnormality in the communication system.

3. The analysis method according to claim 1, further comprising inferring, in a case where the control messages are encrypted, the types of the control messages based on at least packet sizes and frequencies of the control messages.

4. The analysis method according to claim 3, wherein in the inferring of the types of the control messages, in a case where the control messages are encrypted, the types of the control messages encrypted are inferred by using a learning model trained with, as training data, at least packet sizes and frequencies of the control messages that are not encrypted and the types of the control messages.

5. The analysis method according to claim 1, wherein in the generating of the event data, the event data is generated by extracting a parameter with use of a template prepared for each of control protocols.

6. An analysis system comprising at least one processor, the at least one processor carrying out:
a process of acquiring control messages exchanged between a plurality of communication apparatuses included in a communication system;
a process of generating, based on the control messages, metrics data which is statistical information, for each of the types of the control messages;
a process of generating, based on the control messages, event data which is history information on the control messages; and
a process of detecting, based on the metrics data and the event data, occurrence of abnormality in the communication system.

7. The analysis system according to claim 6, wherein the at least one processor further carries out a process of identifying, based on at least one of the metrics data and the event data, a cause of the occurrence of the abnormality in the communication system.

8. The analysis system according to claim 6, wherein the at least one processor further carries out a process of inferring, in a case where the control messages are encrypted, the types of the control messages based on at least packet sizes and frequencies of the control messages.

9. The analysis system according to claim 8, wherein in the process of inferring the types of the control messages, in a case where the control messages are encrypted, the at least one processor infers the types of the control messages encrypted, by using a learning model trained with, as training data, at least packet sizes and frequencies of the control messages that are not encrypted and the types of the control messages.

10. The analysis system according to claim 6, wherein in the process of generating the event data, the at least one processor generates the event data by extracting a parameter with use of a template prepared for each of control protocols.

11. A non-transitory storage medium storing a program for causing a computer to carry out:
a process of acquiring control messages exchanged between a plurality of apparatuses communication included in a communication system;
a process of generating, based on the control messages, metrics data which is statistical information, for each of the types of the control messages;
a process of generating, based on the control messages, event data which is history information on the control messages; and
a process of detecting, based on the metrics data and the event data, occurrence of abnormality in the communication system.

12. The non-transitory storage medium according to claim 11, wherein the computer is caused to further carry out a process of identifying, based on at least one of the metrics data and the event data, a cause of the occurrence of the abnormality in the communication system.

13. The non-transitory storage medium according to claim 11, wherein the computer is caused to further carry out a process of inferring, in a case where the control messages are encrypted, the types of the control messages based on at least packet sizes and frequencies of the control messages.

14. The non-transitory storage medium according to claim 13, wherein in the process of inferring the types of the control messages, in a case where the control messages are encrypted, the types of the control messages encrypted are inferred by using a learning model trained with, as training data, at least packet sizes and frequencies of the control messages that are not encrypted and the types of the control messages.

15. The non-transitory storage medium according to claim 11, wherein in the process of generating the event data, the event data is generated by extracting a parameter with use of a template prepared for each of control protocols.
